(19) United States
(12) Patent Application Publication
(10) Pub. No.: US 2010/0094790 A1
(43) Pub. Date: Apr. 15, 2010

(54) MACHINE LEARNING OF DIMENSIONS USING SPECTRAL INTENSITY RESPONSE OF A REFLECTOMETER

(75) Inventor: Joe Gnojewski, Boise, ID (US)

Correspondence Address: SCHWEGMAN, LUNDBERG & WOESSNER/MICRON, P.O. BOX 2938, MINNEAPOLIS, MN, 55402, US

(73) Assignee: Micron Technology, Inc.

(21) Appl. No.: 12/249,757

(22) Filed: Oct. 10, 2008

(51) Int. Cl. G06N 3/08

(52) U.S. Cl. 706/25

(57) ABSTRACT

A method and a system for determining critical dimensions using an artificial neural network, where the artificial neural network is trained based on a spectral intensity response of a reflectometer are provided. Additional apparatus, systems, and methods are disclosed.

### BACKGROUND

Artificial Neural Networks (ANN) are adaptive, often nonlinear modeling systems that are capable of learning to perform a function from data. The function may include an input/output mapping and the data may include input data and output target data. During the training phase, ANN system parameters are allowed to change to achieve a consistent mapping between input and the target output data. After the training phase, during the measuring phase, the ANN system parameters are fixed and the system may be deployed to solve a problem at hand.

Artificial neural networks have been used in many technological disciplines to solve complex problems. Example applications of ANN may include complex mapping, adaptive control, pattern recognition, machine vision, signal filtering, data segmentation, and data mining.

### BRIEF DESCRIPTION OF THE DRAWINGS

Some embodiments of the invention are illustrated by way of example and not limitation in the figures of the accompanying drawings in which:

FIG. 1 is a block diagram illustrating an example embodiment of a system for determining dimensions of a sample using an artificial neural network, where the artificial neural network is trained based on the spectral intensity response of a reflectometer;

FIG. 2 a block diagram illustrating an example embodiment of a system for determining dimensions using an artificial neural network, where the artificial neural network is trained based on a simulated spectral intensity response;

FIG. 3 is a block flow diagram illustrating an example embodiment of a method for determining dimensions using an artificial neural network, where the artificial neural network is trained based on the spectral intensity response of a reflectometer;

FIG. 4 is a block flow diagram illustrating an example embodiment of a method for determining dimensions using an artificial neural network, where the artificial neural network is trained based on a simulated spectral intensity response;

FIG. 5 illustrates a flow diagram illustrating an example embodiment of a method for training an artificial neural network for determining dimensions.

FIG. 6 is a flow diagram illustrating an example embodiment of a learning phase for training an artificial neural network for determining dimensions based on spectral intensity response;

FIG. 7 is a flow diagram illustrating an example embodiment of a measurement phase using an artificial neural network for determining dimensions based on spectral intensity response;

FIG. 8 is a screen shot illustrating an example embodiment of a graphical user interface (GUI) used for training an artificial neural network for determining dimensions based on spectral intensity response;

FIG. 9 is a diagram illustrating an example embodiment of a response of an artificial neural network for an oxide fill structure;

FIG. 10 is a diagram illustrating an example embodiment of a response of an artificial neural network for a photo-resist profile;

FIG. 11 is a diagram illustrating an example embodiment of a response of an artificial neural network for a photo-resist feature with added noise; and

FIG. 12 is a diagram depicting an example representation of a machine, according to various embodiments.

### DETAILED DESCRIPTION

Example methods and systems for determining critical dimensions using an artificial neural network, where the artificial neural network is trained based on spectral intensity response of a reflectometer, will be described. In the following description for purposes of explanation, numerous examples having example-specific details are set forth to provide an understanding of example embodiments. It will be evident, however, to one skilled in the art that the present examples may be practiced without these example-specific details.

Some example embodiments described herein may include receiving spectral intensity response (SIR) data from a reflectometer used for analyzing a sample. The term reflectometer shall be taken to include an instrument for measuring a reflectivity or reflectance of a reflecting surface. The term spectral intensity response shall be taken to include a distribution of the reflectance of a beam of light from a surface as a function of the wavelength of the beam of light. Spectral central moments of a reflectometer spectral intensity response data may be determined. The term spectral central moment shall be taken to include a weighted average of the spectral intensity response. An artificial neural network may be trained to generate an output, using the spectral central moments as inputs. The output may include simulated metrological data associated with the sample. The term metrology shall be taken to include theoretical and practical aspects of measurement (e.g., measurement of semiconductor samples).

Other example embodiments may include generating a simulated spectral intensity spectrum associated with a structure, using a Rigorous Coupled Wave Analysis (RCWA). The RCWA is a method for generating spectra associated with a two-dimensional structure (e.g., a diffraction limited grating) by simulating the spectra. This method is based on solving the Maxwell's equation for a known structure to obtain a simulated SIR associated with the known structure. Spectral central moments of the simulated spectral intensity spectrum may be determined and used as inputs for training an artificial neural network. Output data may be generated using the artificial neural network. The output data may include simulated metrology data associated with the inputs. The simulated metrology data may be displayed to a user.

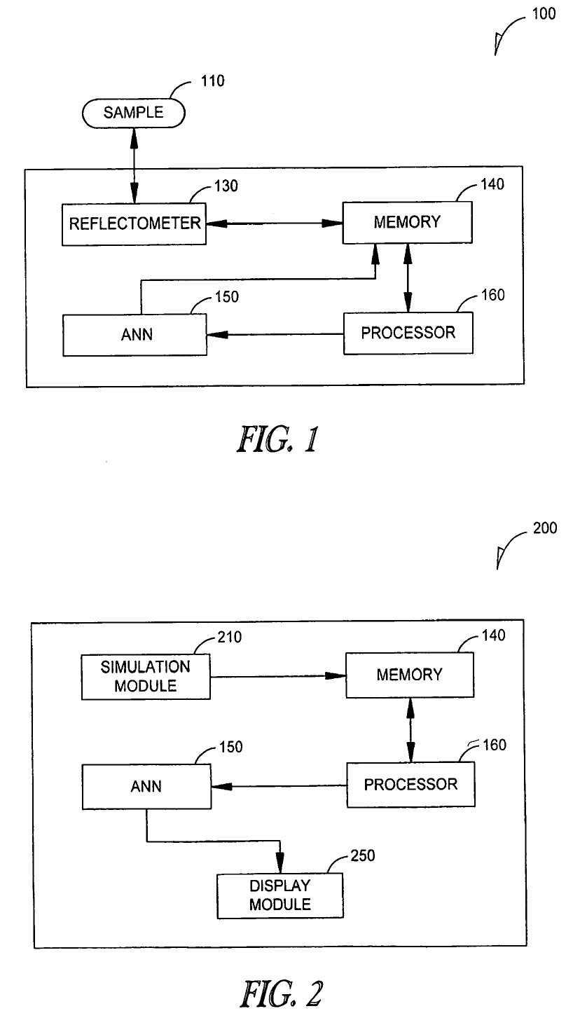

FIG. 1 is a block diagram illustrating an example embodiment of a system 100 for determining dimensions of a sample 110 using an artificial neural network (ANN) 150, where ANN 150 is trained based on the spectral intensity response of a reflectometer 130. The determined dimensions of sample 110 may be critical dimensions of the sample. Reflectometer 130 may be a polarized reflectometer, a spectrometer, an optical time domain reflectometer, or other similar device. Reflectometer 130 may be used to measure spectral intensity response (SIR) of a sample 110. Sample 110 may be a semiconductor sample/wafer, a biological sample, a biochemical/chemical sample, or other sample for which dimensions are to be determined. Example embodiments may relate to, but are not limited to, determining critical dimensions, feature sizes, layer thicknesses, and/or endpoints of semiconductor processes. The semiconductor processes may include, but are not limited to, removal of a silicon dioxide layer using a Chemical Mechanical Planarization (CMP) technique. The silicon dioxide layer to be removed may cover a grating structure that includes active regions such as, but not limited to, transistors.

The CMP technique may use both physical and chemical objects to achieve planarization. The physical object may include a solid material with similar hardness as the sample surface. The chemical object may include chemicals such as hydrofluoric Acid (HF) or potassium hydroxide (KOH). The solid material may be suspended in the chemical forming a slurry. Post-polish cleans may be used as part of the CMP technique to remove the slurry from the surface of the sample after removal of a silicon dioxide layer, before subjecting the sample to reflectometry or other metrology measurements

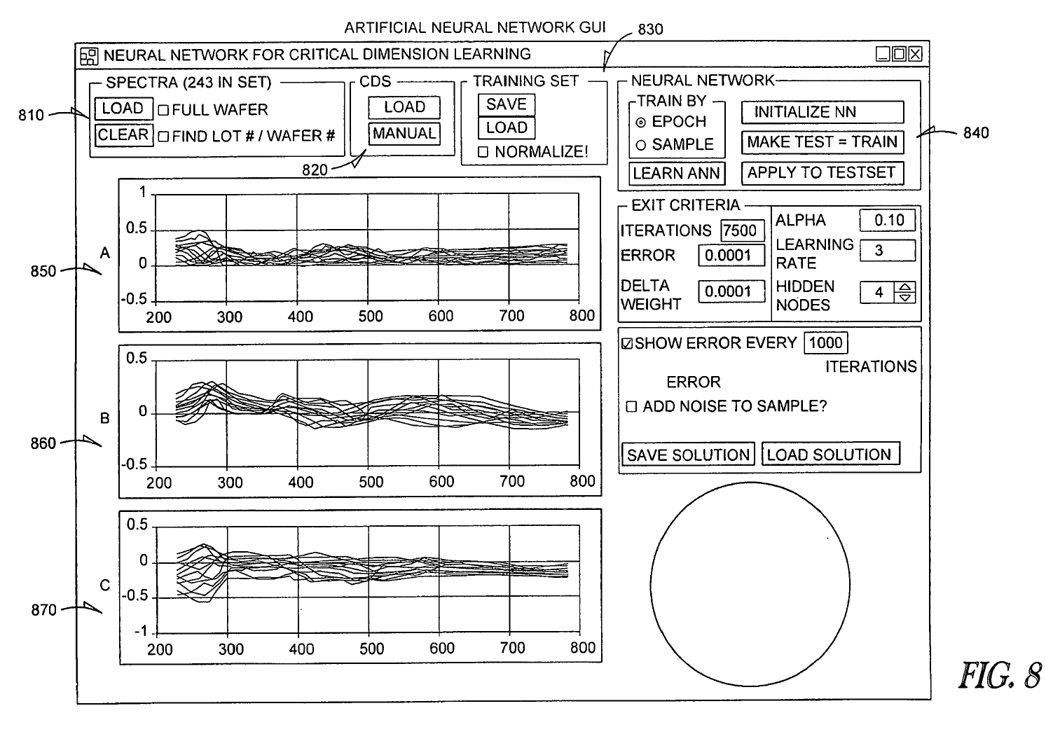

The reflectometer 130 measurements may be made at certain points on the sample. The result of the reflectometer 130 measurements may include SIRs such as the spectra shown in FIG. 8 (see spectra 850, 860, and 870). A SIR is an intensity versus wavelength function that defines an intensity at a certain wavelength. The intensity may be provided as a reflection coefficient at the certain wavelength. The SIRs may be stored in a memory 140. An SIR may include a large set of data points, for example, a set of 4096 data points. Applying a data set including such a large number of data points as inputs for training an artificial neural network (ANN) 150 may not be practical. As a method of compressing the data set, the processor 160 may be used to automatically determine the spectral central moments of the reflectometer SIR data to reduce the amount of data to be used.

The spectral central moments may be viewed as a compressed form of the SIR data. For example, converting the SIR data into 3^{rd} order spectral central moments may compress a set of 2048 data points into eight central moments for each polarization. The spectral central moments may represent certain weighted averages of the set of 2048 data points computed by the processor 160. Considering that a reflectometer 130 may be a polarized reflectometer that may generate an SIR including a set of 4096 data points for both polarizations, the total number of spectral central moments generated by the processor 160 for the two polarizations of the reflectometer 130 may include 16 points (i.e., 2*8).

In various embodiment, the spectral central moments associated with the SIRs resulting from a number of measurements may be used as inputs to the ANN 150 to train the ANN 150. Training of the ANN 150, as described below, may include determining values for a number of synaptic weights (e.g., weighting functions) through several iterations such that the outputs closely represent metrology results corresponding to SIRs. The term synaptic may be an indication of an analogy between the functionality of brain nerve synapses and the connectivity between nodes of an ANN. The simulated results obtained from a trained ANN may represent expected values resulting from the measurement of the same feature (e.g., a thickness of a layer) measured by the reflectometer, as measured by a metrology tools such as electron scanning microscope (SEM), and tunneling electron microscope (TEM).

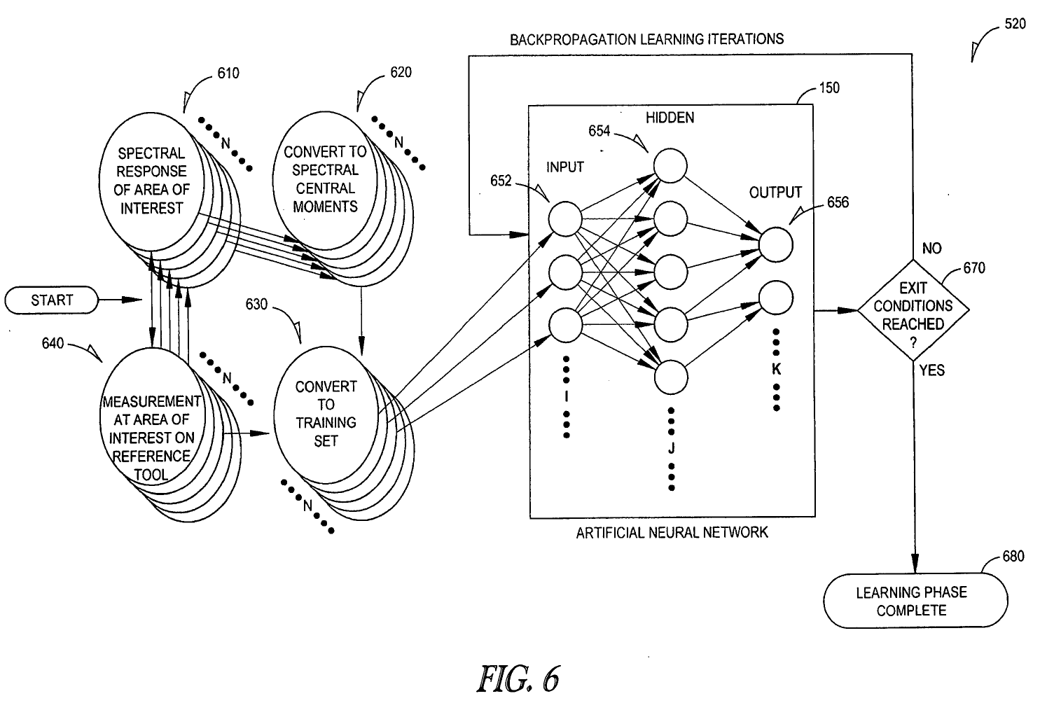

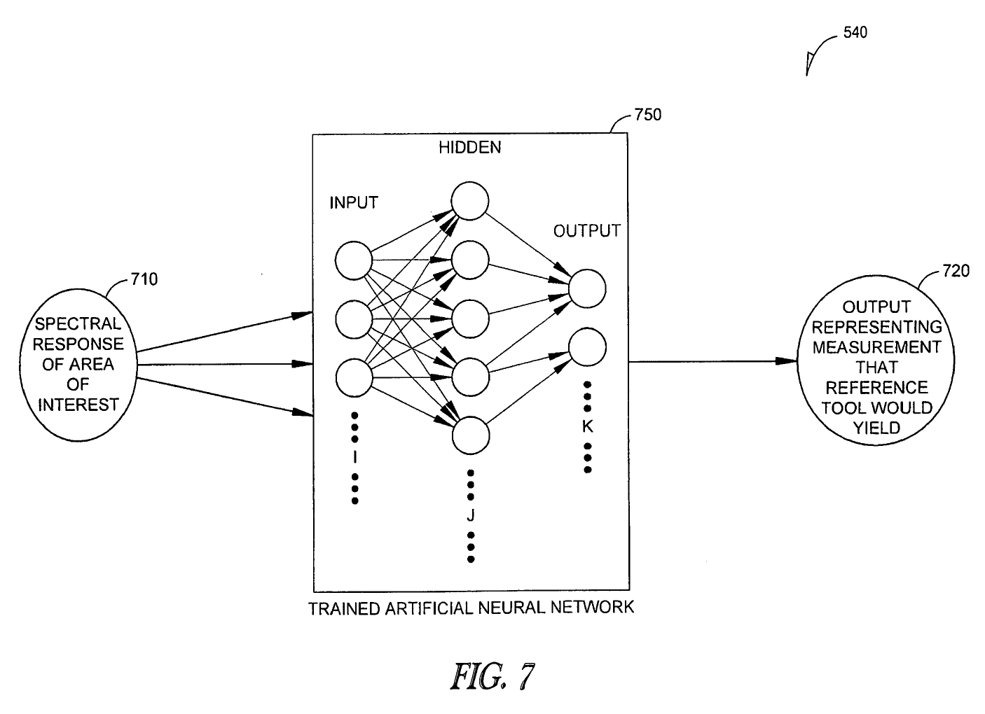

A typical ANN may include a predefined number of input, output, and hidden nodes connected via synaptic interconnects (see arrows connecting input nodes 652 to hidden nodes 654 and hidden nodes 654 to output nodes 656 in ANN 150 in FIG. 6) represented by weighting functions (e.g., Wⱼᵢ connecting hidden node number j to input node number i and Wₖⱼ connecting output node number k to hidden node number j). In a learning phase, as described in more detail below, the spectral central moments of the reflectometer measured SIR (e.g., inputs) and the metrology tool measurement results corresponding to the measured SIRs (e.g., target outputs) may be used to determine values for the weighting functions connecting input nodes (see, for example, reference number 652 in FIG. 6) to hidden nodes (see, for example, reference number 654 in FIG. 6) and hidden nodes to output nodes (see, for example, reference number 656 in FIG. 6) via a number of iterations. In the measurement phase, the trained ANN (e.g., with pre-determined weighting functions, as trained ANN 750 in FIG. 7) is used to determine the expected metrology tool measurement results using the reflectometer measured SIRs, without using the actual metrology tool.

Various embodiments of methods and systems as taught herein may replace the use of the more expensive and complex metrology tools such as a SEM for measuring samples by replacing the metrology tool with a reflectometer measurement, which can be easier and faster to use, followed by a ANN measurement. The end result may be a faster measuring technique with lower operational cost.

In an alternative example embodiment, as shown in FIG. 2, instead of using the reflectometer 130 to measure SIRs associated with a structure (e.g., a multilayer structure on a semiconductor wafer, a grating, etc.), the system 200 may use a simulation module 210 to simulate the SIRs. The simulation module 210 may use techniques such as RCWA to simulate the SIR. The RCWA is a method for generating spectra associated with a two-dimensional structure (e.g., a diffraction limited grating) by simulating spectra, which could be expected to be acquired when a reflectometer is used to measure the same structure. This method is based on solving the Maxwell's equation for a known structure to obtain a simulated SIR associated with the known structure. The simulated SIR may relate to a number of measured dimensions associated with the known structure, including critical dimensions (e.g., dimension of smallest feature sizes in semiconductor technology). The measured dimensions of the known structure may be used as the input parameters of the RCWA.

The system 200 may include a memory 140 to store the simulated SIR generated by the simulation module 210. The system 200 may include a processor 160, an ANN 150, and a display module 250. The processor 160 may be used to automatically determine the spectral central moments of the simulated spectra using a pre-defined algorithm. The spectral central moments may be applied as inputs to the ANN 150 to train the ANN 150. The ANN 150, once trained, may be used to generate output data. The output data may include simulated metrology data associated with the inputs. The display module 250 may display the output data to a user. The display module 250 may also display graphical user interfaces (GUI) (e.g., GUI shown in FIG. 8) that may facilitate training of the ANN 150. The system 200 may also include an error analysis module 260. The error analysis module 260 may simulate an effect of a metrology system error on the output data of the ANN 150 by including a predefined uncertainty in a measured dimension of the structure before generating the simulated spectrum (see discussion of FIG. 11 below).

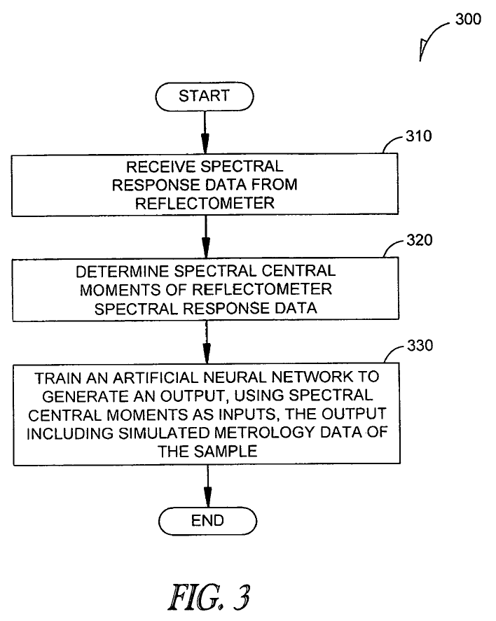

FIG. 3 is a flow diagram illustrating an example embodiment of a method 300 for determining dimensions using an artificial neural network, where the artificial neural network is trained based on the spectral intensity response of a reflectometer. At operation 310, SIR data is received from reflectometer 130 (see FIG. 1), where the SIR data can be used to analyze the sample 110 (see FIG. 1), for example, to measure critical dimensions or dimensions associated with structures, such as multilayer structure, or provide other analysis. The processor 160 (see FIG. 1), at operation 320, determines the spectral central moments of the SIR received from the reflectometer 130. At operation 330, ANN 150 is trained using the spectral central moments as the inputs to the ANN 150 to generate an output. The output may be, but is not limited to a simulated metrology result such as a critical dimension or a thickness of a layer in a structure.

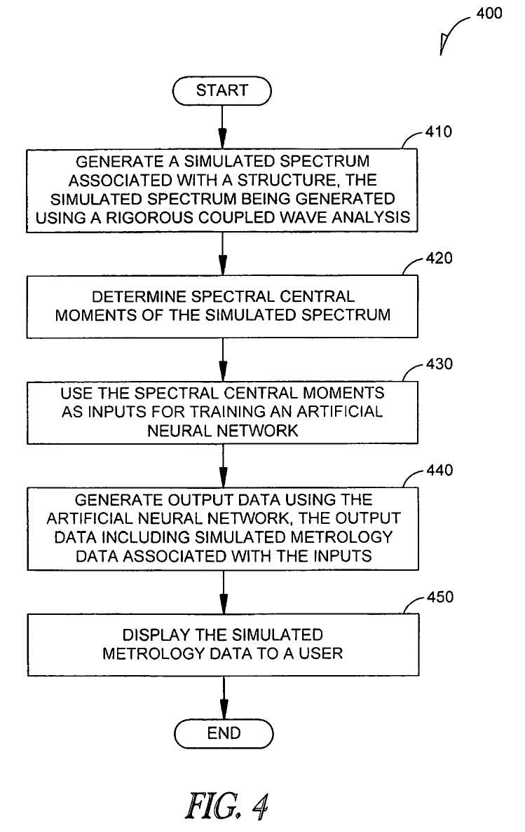

FIG. 4 is a flow diagram illustrating an example embodiment of a method 400 for determining critical dimensions using an artificial neural network where the artificial neural network is trained based on a simulated SIR. At operation 410, the simulation module 210 (see FIG. 2) generates a simulated SIR associated with a structure. According to example embodiments, the structure may include a multilayer structure including transistor active areas and isolation regions. The simulation module 210 may use the RCWA technique discussed above to simulate the SIR. The simulated SIR data including, for example, 4096 data points, may be stored in the memory 140 (see FIG. 2). The simulated SIR may relate to a number of measured dimensions associated with the structure, including critical dimensions.

The processor 160 (see FIG. 2), at operation 420, may retrieve the SIR data from the memory 140 and automatically determines the spectral central moments of the simulated SIR. The spectral central moments may be stored in memory 140. At operation 430, the stored spectral central moments are applied as inputs to the ANN 150 to train the ANN 150. After training, the ANN 150, at operation 440, generates output data. The output data may include simulated metrology data associated with the inputs. At operation 450, the display module 250 (see FIG. 2) displays the simulated metrology data to a user.

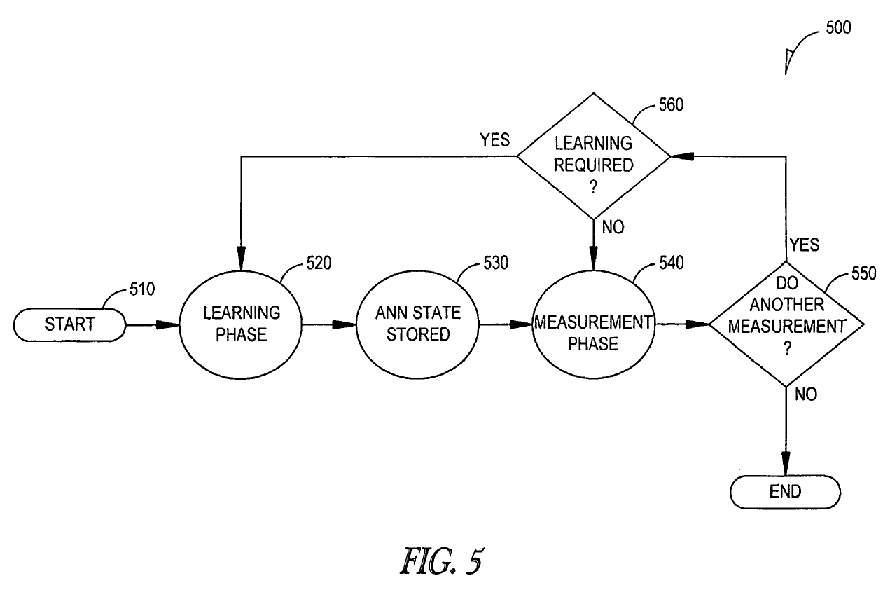

FIG. 5 illustrates a flow diagram illustrating an example embodiment of a method 500 for training an artificial neural network for determining dimensions such as critical dimensions of a sample. The training of the artificial neural network includes changing synaptic weights (e.g., weighting functions) after one sample or an entire set of samples in a training set of samples has been analyzed. At operation 510, the training process starts with preparing inputs and target outputs for feed-forward propagation through the ANN 150. The inputs may include spectral central moments of a measured SIR (e.g., using the reflectometer 130 in FIG. 1) or a simulated SIR (e.g., the SIR generated by the simulation module 210 in FIG. 2). The target outputs may include actual measured dimensions, including critical dimensions, associated with a structure (e.g., a multilayer structure including transistor active areas and isolation regions).

The feed-forward propagation may start with using the prepared set of inputs along with a set of initial values for the weighing functions relating the hidden nodes to the input nodes (Wⱼᵢ) and output nodes to the hidden nodes (Wₖⱼ) of the ANN 150 (see ANN 150 in FIG. 6). The initial values of the weighting functions may be selected on a random basis such that the values meet certain conditions defined by the number of output nodes and hidden nodes. Using the prepared set of inputs and the initial values of the weighting functions the first set of outputs may be determined and compared with the target outputs to find errors.

A cost function may be defined to evaluate a cumulative error at each output node. The cost function may be function showing a relationship between the cumulative errors at each output node as a function of the weighting functions. The minimization of the cost function through a number of iterations may form the basis of a back-propagation of parameters of the ANN 150. In the back-propagation, the ANN 150 may iterate through a process of training by changing the weighting functions according to predefined guidelines until some exit conditions are fulfilled. The exit condition may be defined based on a maximum number of iterations (e.g., 100), convergence of the cost function error below a predefined limit (e.g. 0.001), or the changes in weighing functions being less than a predefine threshold. The weighting function changes may occur at different times during the learning phase depending on the training approach selected by a user.

During the learning phase 520, a user may select to train the ANN 150 either by an epoch approach or by a randomly selected sample in a training set. The training set may include a number of sets of spectral central moments. A set of spectral central moments may include data points corresponding to two polarizations of the reflectometer 130 (see FIG. 1). In the epoch approach, the change in the weighting functions may occur after using multiple sets of spectral central moments. Whereas, in the randomly selected sample approach, the change in the weighting functions may occur after applying one set of inputs (e.g. a set of spectral central moments) to the ANN 150.

Once one of the exit conditions has been fulfilled and the learning phase is completed, at block 530 the parameters of the ANN 150 (e.g., the final values of the weighting functions) may be stored in memory 140 (see FIG. 1/2). Having the final values of the weighting functions stored, the ANN 150 is ready for the measurement phase 540. In the measurement phase 540, for a set of input spectral central moments, using the stored set of parameters, the ANN 150 can automatically generate a corresponding set of outputs (e.g., simulated metrology data associated with the input spectral central moments).

At the decision block 550, the ANN 150 may check whether the user wants to perform further measurements. In cases where further measurements are requested, the control is passed to the decision block 560. At decision block 560, the ANN 150 may determine whether a new learning has to be performed, for example, if the user wants to train the ANN 150 for a new scenario (e.g., measurement of a new sample with different structure). In cases where a new scenario is to be run, the control is passed to the learning phase 520, where a new training may take place. Otherwise, control is passed to the measurement phase 540 discussed above. Returning to the decision block 550, if the user does not want to perform further measurement the training ends.

FIG. 6 is a flow diagram illustrating an example embodiment of a learning phase 520 for training an artificial neural network for determining dimensions based on SIR. The dimensions may be critical dimensions of one or more samples. In the learning phase 520, a set of N SIR data (see block 610) corresponding to N reflectometer measurements (e.g., measurement of dimensions) at N areas of interest on one or more samples are converted, at block 620, to N sets of spectral central moments by the processor 160 (see FIG. 1). At block 630, N training sets including N sets of spectral central moments from the block 620 and N target outputs resulting from N measurement by a reference tool (at block 640) are formed and applied for training the ANN 150.

Back-propagation learning iterations may continue until, at decision block 670, it is ascertained that the exit conditions are fulfilled. When the exit conditions are fulfilled, the learning phase may be completed (block 680), and the ANN 150 may be ready for measurement phase 540.

In the measurement phase 540, as shown in FIG. 7 at block 710, the spectral intensity responses of areas of interest on the samples having similar features as the samples used for training the ANN 150 may be measured and converted to spectral central moments (SCM) at block 712. The SCM may then be applied, block 715, to the inputs of the trained ANN 750. The outputs of the trained ANN 750 (block 720) represent expected reference metrology tool measurement results on the same areas of the same samples. In other words, the trained ANN 750 may simulate the reference metrology tool.

Using the trained ANN 750 to simulate the reference metrology tools may include saving samples that otherwise may have been destroyed in the process of preparation of measureable samples for the reference metrology tool. For example, for SEM, which examines cross sections of the samples to measure thickness layer of various layers deposited on the sample, small samples may be prepared by cutting the samples into small pieces. In addition, the trained ANN 750 measurement results may also be free from human and system errors involved in typical reference tool measurements.

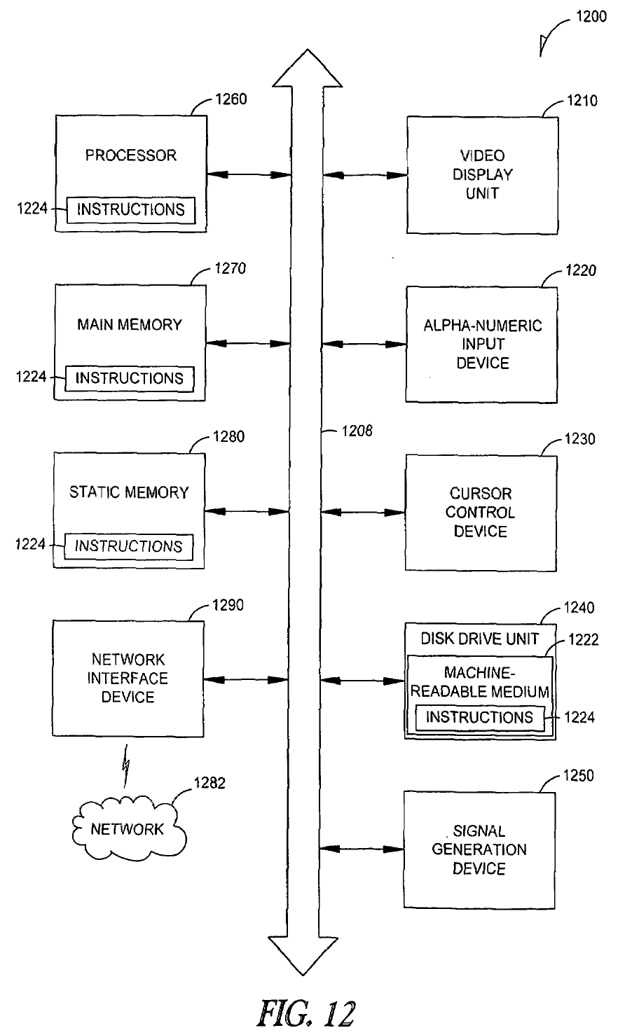

FIG. 8 is a screen shot illustrating an example embodiment of a graphical user interface (GUI) 800 used for training an artificial neural network for determining dimensions based on spectral intensity response. The GUI 800 may be configured as a Microsoft Windows™ compatible application. A user may start at portion 840 of the GUI 800, where the user initializes the ANN 150 and may select either the epoch or the sample approach for training the ANN 150. Using the portion 840, the user may, for example, specify parameters including the number of hidden nodes and exit criteria, such as the number of iterations (e.g., 7500), delta weight (e.g., change in weight functions), or error (e.g., cost function error). Using the load button 810, the user may import the SIR directly from a reflectometer or from a memory (e.g., memory 140 in FIG. 1 or main memory 1270 in FIG. 12) to the ANN 150 and specify whether the SIR is associated with a full wafer or certain lots on the wafer. The load button 810 may allow the user to load measured critical dimensions to be used as the target outputs. Alternatively, the user may manually input the measured critical dimensions by pressing the manual button. The GUI 800 may provide visual feedback to the user by showing a graphical view of the spectral intensity responses 850, 860, and 870 as imported to the ANN 150.

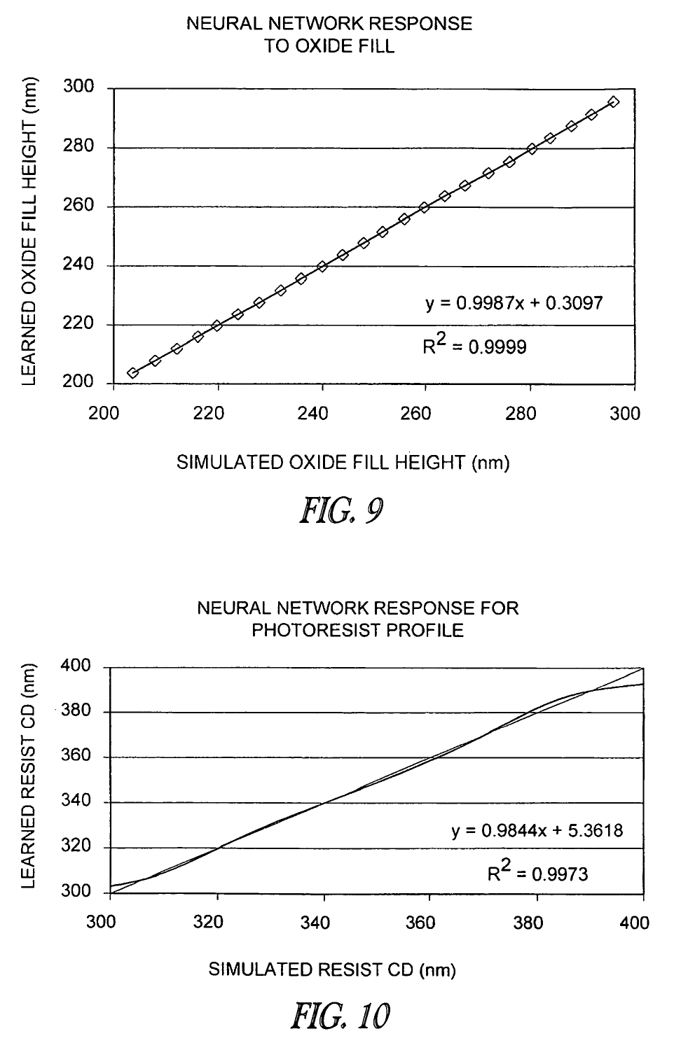

FIG. 9 is diagram illustrating an example embodiment of a response of an artificial neural network for an oxide fill structure. The horizontal axis represents the simulated oxide fill heights in nanometers (nm). The simulated oxide fill heights are the actual measured oxide fill heights applied in the simulation of the SIRs (using the RCWA technique) used in preparing inputs for the ANN 150. The oxide fill height may be the thickness of a silicon dioxide layer covering a structure. The oxide fill may be gradually removed at 4 nm steps, and after every step, SIR data may be taken with a reflectometer or calculated with the RCWA technique described above. The SIR data may be converted to spectral central moments and used as inputs to ANN 150. The learned oxide fill heights shown on the vertical axis are the outputs of the ANN 150 corresponding to the inputs. As shown, the learned oxide fill heights are in agreement with the simulated oxide fill heights.

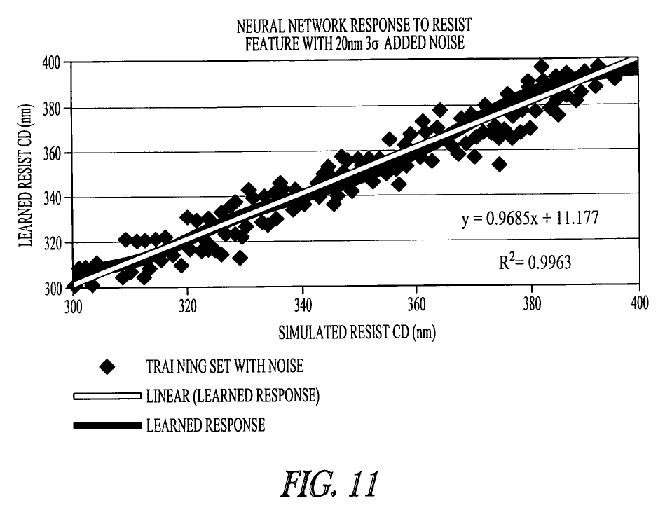

FIG. 10 is diagram illustrating an example embodiment of a response of an artificial neural network for a photo-resist profile. The sample used for generating data for FIG. 10 may be a silicon sample with a rectangle of a photo-resist layer on the top of the sample. The dispersion parameters of the photo-resist layer may be obtained and applied to generate simulated SIR using the RCWA technique. The generated simulated SIR may then be converted to spectral central moments and used as inputs to the ANN 150 to produce the learned resist critical dimension (CD) shown on the vertical axis of FIG. 10. The numbers on the horizontal axis represent the simulated resist CD, which are the actual measured CD applied in the simulation of the SIRs (using the RCWA technique) used in preparing inputs for the ANN 150. The learned resist CD numbers shown on the vertical axis represent outputs of the ANN 150 corresponding to the inputs.

FIG. 11 is diagram illustrating an example embodiment of a response of an artificial neural network for a photo-resist feature with added noise. The purpose of adding noise is to simulate the effect of uncertainty associated with a metrology system error (e.g., systematic and human errors, etc. in actual measurements in a lab setting) on the output data of the ANN 150 by including a predefined uncertainty (e.g., added noise) in the measured dimension of a sample analyzed by a reflectometer or a structure for which a simulated SIR is generated, before generating the SIR used for training the ANN 150. The method for generating data for FIG. 11 is similar to the method used for FIG. 10, except for the addition of noise. The added noise may in fact be introduced in the form of uncertainty in the measured critical dimensions. The results shown in FIG. 11 may be obtained by adding a Gaussian noise with 3σ of 20 nm to the photo-resist feature as was described with respect to FIG. 10.

FIG. 12 is a diagram illustrating an example representation of a machine 1200, according to various embodiments. In an example embodiment, machine 1200 includes a set of instructions that may be executed to cause machine 1200 to perform any one or more of the methodologies discussed herein. In alternative embodiments, the machine 1200 may operate as a standalone device or may be connected (e.g., networked) to other machines. In a networked deployment, the machine 1200 may operate in the capacity of a server or a client machine in a server-client network environment or as a peer machine in a peer-to-peer (or distributed) network environment. Machine 1200 may be realized in the form of a computer.

The machine 1200 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example machine 1200 may include a processor 1260 (e.g., a central processing unit (CPU), a graphics processing unit (GPU) or both), a main memory 1270 and a static memory 1280, all of which communicate with each other via a bus 1208. The machine 1200 may further include a video display unit 1210 (e.g., a liquid crystal display (LCD) or cathode ray tube (CRT)). The machine 1200 also may include an alphanumeric input device 1220 (e.g., a keyboard), a cursor control device 1230 (e.g., a mouse), a disk drive unit 1240, a signal generation device 1250 (e.g., a speaker), and a network interface device 1290.

The disk drive unit 1240 may include a machine-readable medium 1222 on which is stored one or more sets of instructions (e.g., software) 1224 embodying any one or more of the methodologies or functions described herein. The instructions 1224 may also reside, completely or at least partially, within the main memory 1270 and/or within the processor 1260 during execution thereof by the machine 1200, with the main memory 1270 and the processor 1260 also constituting machine-readable media. The instructions 1224 may further be transmitted or received over a network 1282 via the network interface device 1290.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium capable of storing, encoding, or carrying a set of instructions for execution by the machine and that cause the machine to perform any one or more of the methodologies of the present technology. The term “machine-readable medium” shall accordingly be taken to include, but not be limited to, solid-state memories and optical and magnetic media.

Embodiments of a method and a system for determining dimensions of a sample using an artificial neural network trained based on spectral intensity response of a reflectometer, which may be applied to determining critical dimensions, have been described. Although the present embodiments have been described, it will be evident that various modifications and changes may be made to these embodiments. Accordingly, the specification and drawings are to be regarded in an illustrative rather than a restrictive sense.

The Abstract of the Disclosure is provided to comply with 37 C.F.R. § 1.72(b), requiring an abstract that allows the reader to quickly ascertain the nature of the technical disclosure. It is submitted with the understanding that it will not be used to interpret or limit the claims. In addition, in the foregoing Detailed Description, it may be seen that various features are grouped together in a single embodiment for the purpose of streamlining the disclosure. This method of disclosure is not to be interpreted as limiting the claims. Thus, the following claims are hereby incorporated into the Detailed Description, with each claim standing on its own as a separate embodiment.

What is claimed is:

1. A method comprising:
receiving spectral intensity response data from a reflectometer to analyze a sample;
determining spectral central moments of the spectral intensity response data; and
training an artificial neural network to generate an output, using the spectral central moments as inputs to the artificial neural network, the output including simulated metrology data associated with the sample.

2. The method of claim 1, wherein the sample is a semiconductor sample.

3. The method of claim 2, wherein the semiconductor sample includes a multilayer structure including transistor active areas and isolation regions.

4. The method of claim 1, wherein determining the spectral central moments includes determining the spectral central moments up to a third order.

5. The method of claim 1, wherein determining the spectral central moments is carried out automatically.

6. The method of claim 1, wherein training the artificial neural network includes changing synaptic weights after one sample in a training set of samples has been analyzed

7. The method of claim 6, wherein the training set of samples includes the spectral central moments.

8. The method of claim 1, wherein training the artificial neural network includes changing synaptic weights after an entire set of samples in a training set of samples have been analyzed.

9. The method of claim 1, wherein the simulated metrology data includes at least one of an endpoint of a process or a critical dimension of a sample.

10. The method of claim 9, wherein the process includes a Chemical Mechanical Planarization (CMP) of the sample.

11. A computerized method comprising:
generating a simulated spectral intensity spectrum associated with a structure, the simulated spectral intensity spectrum being generated using a Rigorous Coupled Wave Analysis;
determining spectral central moments of the simulated spectrum;
using the spectral central moments as inputs for training an artificial neural network;
generating output data using the artificial neural network, the output data including simulated metrology data associated with the inputs; and
displaying the simulated metrology data.

12. The method of claim 11, wherein the structure includes a multilayer structure including transistor active areas and isolation regions.

13. The method of claim 11, wherein the simulated spectral intensity spectrum relates to a plurality of measured dimensions associated with the structure.

14. The method of claim 13, further including simulating an effect of a metrology system error on the output data by including a predefined uncertainty in the measured dimension before generating the simulated spectrum.

15. The method of claim 11, wherein the simulated metrology data includes at least one of an endpoint of a process or a critical dimension of the structure.

16. A machine-readable device including instructions, the instructions when executed by a processor perform the following operations:
generating a simulated spectral intensity spectrum associated with a structure, the simulated spectra being generated using a Rigorous Coupled Wave Analysis;
determining spectral central moments of the simulated spectrum; and
using the spectral central moments as inputs for training an artificial neural network; and
generating output data using the artificial neural network, the output data including simulated metrology data associated with the inputs.

17. The method of claim 16, further including displaying the simulated metrology data.

18. A system comprising:
a reflectometer to analyze a sample;
a memory to store spectral intensity response data received from the reflectometer, the spectral intensity response data corresponding to the sample;
a processor coupled to the memory to determine spectral central moments of the spectral intensity response data; and
an artificial neural network to generate an output, the artificial neural network operatively trained using the spectral central moments as inputs to the artificial neural network, the output including simulated metrology data associated with the sample.

19. The system of claim 18, wherein the reflectometer is configured to analyze a semiconductor sample.

20. The system of claim 18, wherein the processor is configured to determine the spectral central moments up to a third order.

21. The system of claim 18, wherein the artificial neural network is configured such that the artificial neural network is operatively trained by changing synaptic weights after one sample in a training set of samples has been analyzed.

22. The system of claim 18, wherein the artificial neural network is configured such that the artificial neural network is operatively trained by changing synaptic weights after an entire set of samples in a training set of samples have been analyzed.

23. The system of claim 18, further including an error analysis module to simulate an effect of a metrology system error on the output by including a predefined uncertainty in a measured dimension of the sample.

24. A system comprising:
a simulation module to generate a simulated spectral intensity spectrum associated with a structure using a Rigorous Coupled Wave Analysis;
a memory coupled to the simulation module to receive the simulated spectral intensity spectrum from the simulation module;
the memory to store the simulated spectral intensity spectrum received from the simulation module;
a processor coupled to the memory to determine spectral central moments of the simulated spectrum; and
an artificial neural network to generate output data, the artificial neural network operatively trained using the spectral central moments as inputs to the artificial neural network, the output data including simulated metrology data associated with the inputs.

25. The system of claim 24, further including an error analysis module to simulate an effect of a metrology system error on the output data by including a predefined uncertainty in a measured dimension of the structure before generating the simulated spectrum.
